(19) United States
(12) Patent Application Publication
(10) Pub. No.: US 2024/0077726 A1
(43) Pub. Date: Mar. 7, 2024

(54) DISPLAY DEVICE AND OPERATING METHOD THEREOF

(71) Applicant: National Central University, Taoyuan City (TW)

(72) Inventors: Yeh-Wei YU, Taoyuan City (TW); Ko-Ting CHENG, Taoyuan City (TW); Pin-Duan HUANG, Taoyuan City (TW); Ching-Cherng SUN, Taoyuan City (TW)

(21) Appl. No.: 18/059,950

(22) Filed: Nov. 29, 2022

(30) Foreign Application Priority Data
Sep. 6, 2022 (TW) 111133755

(51) Int. Cl. G02B 27/01; G06F 3/01; G09G 3/00

(52) U.S. Cl. CPC G02B 27/0172; G02B 27/0179; G06F 3/013; G09G 3/001; G02B 2027/0118; G02B 2027/0138; G02B 2027/014; G02B 2027/0178; G02B 2027/0187; G09G 2354/00

(57) ABSTRACT

A display device is configured to determine a target location. The display device includes a waveguide element, a display panel and a processor. The waveguide element is configured to receive an image and reflect the image to an eyeball location. The display panel is located at one side of the waveguide element. The display panel has a plurality of pixel units. The display panel is located between the waveguide element and the target location. The processor is electrically connected to the display panel. The processor is configured to determine the pixel units in a blocking area of the display panel to be opaque. The blocking area of the display panel overlaps the target location. The display panel displays the pixel units in the blocking area as grayscale according to the processor.

### RELATED APPLICATION

This application claims priority to Taiwan Application Serial Number 111133755, filed Sep. 6, 2022, which is herein incorporated by reference in its entirety.

### BACKGROUND

### Field of Invention

The present disclosure relates to a display device and an operating method of the display device.

### Description of Related Art

In general, a near-eye display (NED) of an augmented reality (AR) system usually has an image generating unit and a waveguide element, so that an image emitted by the image generating unit may be overlapped with a real scene to provide assistance information to users. However, when the near-eye display reflects the image to the user's eyes through the waveguide element, a virtual object in the image may be overlapped with an object in the real scene, causing the user may consider the virtual object is transparent, so that the user may not clearly observe the image, which may be disadvantageous for an overall viewing experience.

### SUMMARY

An aspect of the present disclosure is related to a display device.

According to one embodiment of the present disclosure, a display device is configured to determine a target location. The display device includes a waveguide element, a display panel and a processor. The waveguide element is configured to receive an image and reflect the image to an eyeball location. The display panel is located at one side of the waveguide element. The display panel has a plurality of pixel units. The display panel is located between the waveguide element and the target location. The processor is electrically connected to the display panel. The processor is configured to determine the pixel units in a blocking area of the display panel to be opaque. The blocking area of the display panel overlaps the target location. The display panel displays the pixel units in the blocking area as grayscale according to the processor.

In one embodiment of the present disclosure, the display device further includes a camera. The camera is electrically connected to the processor.

In one embodiment of the present disclosure, the camera is configured to detect the eyeball location.

In one embodiment of the present disclosure, the camera is located between the eyeball location and the display panel.

In one embodiment of the present disclosure, the waveguide element is located between the eyeball location and the display panel.

In one embodiment of the present disclosure, the waveguide element is closer to the eyeball location than the display panel.

In one embodiment of the present disclosure, the display panel is closer to the target location than the waveguide element.

In one embodiment of the present disclosure, the blocking area of the display panel partially overlaps the eyeball location.

In one embodiment of the present disclosure, the processor is configured to determine the blocking area of the display panel according to the target location.

In one embodiment of the present disclosure, the processor is configured to determine the blocking area of the display panel according to the eyeball location.

In one embodiment of the present disclosure, the waveguide element and the display panel are separated from each other.

An aspect of the present disclosure is related to an operating method of a display device.

According to one embodiment of the present disclosure, an operating method of a display device includes: determining a target location; receiving an image by a waveguide element; reflecting the image to an eyeball location by the waveguide element; determining a plurality of pixel units in a blocking area of a display panel located between the target location and the waveguide element to be opaque, wherein the blocking area overlaps the target location; and displaying the pixel units in the blocking area as grayscale.

In one embodiment of the present disclosure, determining the pixel units in the blocking area to be opaque is performed according to the eyeball location.

In one embodiment of the present disclosure, determining the pixel units in the blocking area to be opaque is performed according to the target location.

In one embodiment of the present disclosure, determining the pixel units in the blocking area to be opaque is performed such that the blocking area of the display panel partially overlaps the eyeball location.

In one embodiment of the present disclosure, the method further includes detecting the eyeball location by a camera.

In one embodiment of the present disclosure, determining the pixel units in the blocking area of the display panel to be opaque further includes determining the pixel units of the display panel outside the blocking area to be transparent.

In the embodiments of the present disclosure, the processor of the display device may determine the blocking area overlapping the target location, and the display panel of the display device may display the pixel units in the blocking area as grayscale according to instructions of the processor. Therefore, when a user wears the display device, the display device may overlap the image with the real scene, and the blocking area of the display panel may block an object located at the target location (such as behind a virtual object in the image). The user may avoid observing the virtual object in the image and the object located at the target location at the same time to improve the authenticity of the image, thereby improving an overall viewing experience.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a stereoscopic view of a wearable device according to one embodiment of the present disclosure.

FIG. 1B illustrates a cross-sectional view of a display device in FIG. 1A along a line segment 1B-1B.

FIG. 2 illustrates a schematic view of using the display device in FIG. 1B.

FIG. 3 illustrates a schematic view of an eyeball location, a display panel and a target location according to one embodiment of the present disclosure.

FIG. 4 illustrates a flow chart of an operating method of display device according to one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper,” “front,” “back” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

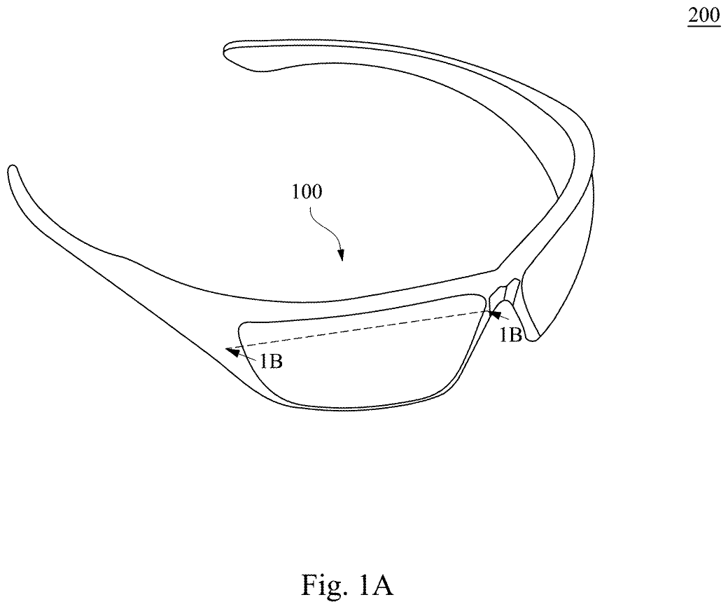

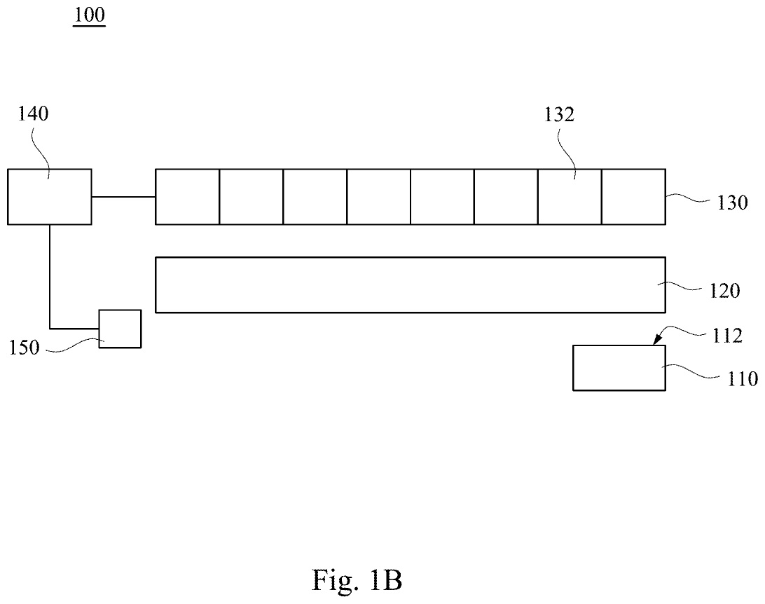

FIG. 1A illustrates a stereoscopic view of a wearable device 200 according to one embodiment of the present disclosure. For example, the wearable device 200 may be an augmented reality (AR) glass or a head-mounted display (HMD), but it is not limited in this regard. The wearable device 200 includes a display device 100. The display device 100 may be a portion of the augmented reality glass or the head-mounted display, so when a user wears the augmented reality glass or the head-mounted display, the user may receive the information provided by the display device 100 and combine the information of the display device 100 with the information of ambient light (such as the real scene).

FIG. 1B illustrates a cross-sectional view of the display device 100 in FIG. 1A along a line segment 1B-1B. The display device 100 includes an image generating unit 110, a waveguide element 120, a display panel 130 and a processor 140. The display panel 130 of the display device 100 may be located at one side of the waveguide element 120, and the waveguide element 120 may be located between the image generating unit 110 and the display panel 130. The display panel 130 has a plurality of pixel units 132. In some embodiments, the waveguide element 120 and the display panel 130 are separated from each other. The processor 140 of the display device 100 is electrically connected to the display panel 130.

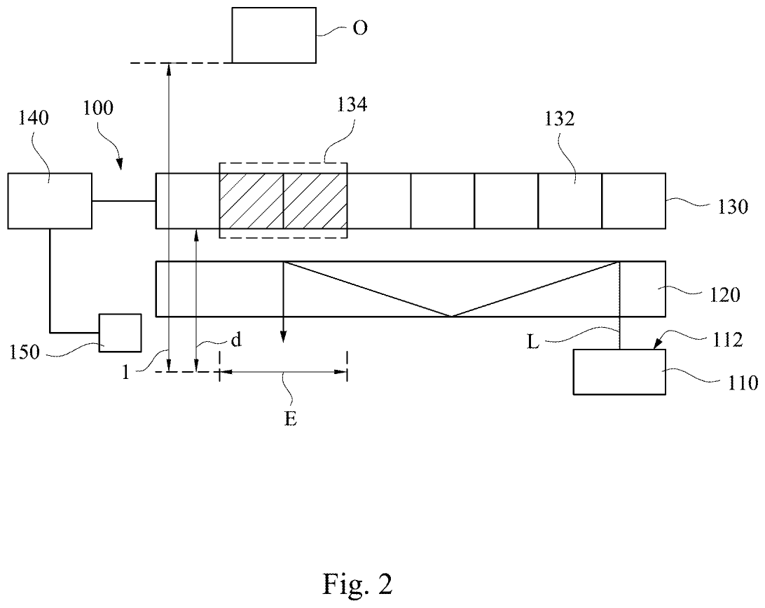

FIG. 2 illustrates a schematic view of using the display device 100 in FIG. 1B. After the user wears the display device 100, the display device 100 may determine a target location O. For example, the display device 100 may include an electronic element to receive an input image to determine the target location O. The image generating unit 110 of the display device 100 has a light emitting surface 112, and the image generating unit 110 may transmit an image L from the light emitting surface 112 to the waveguide element 120. For example, the waveguide element 120 may have different coupling gratings to receive the image L and make the image L to be totally reflected in the waveguide element 120. Then, the waveguide element 120 may reflect the image L to an eyeball location E through the coupling gratings. The user's eyes may be located at the eyeball location E to receive the image L transmitted by the image generating unit 110. In addition, the waveguide element 120 is closer to the eyeball location E than the display panel 130.

In addition, the image L may be combined with the information of the real scene and may be transmitted to the eyeball location E. In some embodiments, the pixel units 132 of the display panel 130 are located between the waveguide element 120 and the target location O. The processor 140 is electrically connected to the display panel 130, and the processor 140 may determine a blocking area 134 of the display panel 130 according to the target location O. To be more specific, the blocking area 134 of the display panel 130 overlaps the target location O. In some embodiments, the pixel units 132 (such as the oblique lines in FIG. 2) located in the blocking area 134 may be an opaque state. That is, after the processor 140 determines the blocking area 134 of the display panel 130, the pixel units 132 located in the blocking area 134 may display as grayscale to block the object located at the target location O, so that the user does not observe the object located at the target location O.

Particularly, the processor 140 of the display device 100 may determine the blocking area 134 overlapping the target location O, and the display panel 130 of the display device 100 may display the pixel units 132 in the blocking area 134 as grayscale according to instructions of the processor 140. Therefore, when the user wears the display device 100, the display device 100 may overlap the image L with the real scene, and the blocking area 134 of the display panel 130 may block the object located at the target location O (such as behind a virtual object in the image L). The user may avoid observing the virtual object in the image L and the object located at the target location O at the same time. The authenticity of the image L is improved, thereby improving an overall viewing experience.

In some embodiments, the display device 100 further includes a camera 150. The camera 150 of the display device 100 is electrically connected to the processor 140, and the camera 150 may detect the eyeball location E. Specifically, the processor 140 determines the blocking area 134 of the display panel 130 according to the target location O and the eyeball location E. For example, after detecting the eyeball location E, the camera 150 may transmit coordinates of the eyeball location E to the processor 140, and the processor 140 may determine the blocking area 134 of the display panel 130 by mathematical formulas (will be described below). In some embodiments, the camera 150 may be located between the eyeball location E and the display panel 130, and the waveguide element 120 may be located between the eyeball location E and the display panel 130. The waveguide element 120 is closer to the eyeball location E than the display panel 130, and the blocking area 134 of the display panel 130 partially overlaps the eyeball location E. The display panel 130 is closer to an object located at the target location O than the waveguide element 120. A distance d between the eyeball location E and the display panel 130 is less than a distance I between the eyeball location E and the target location O.

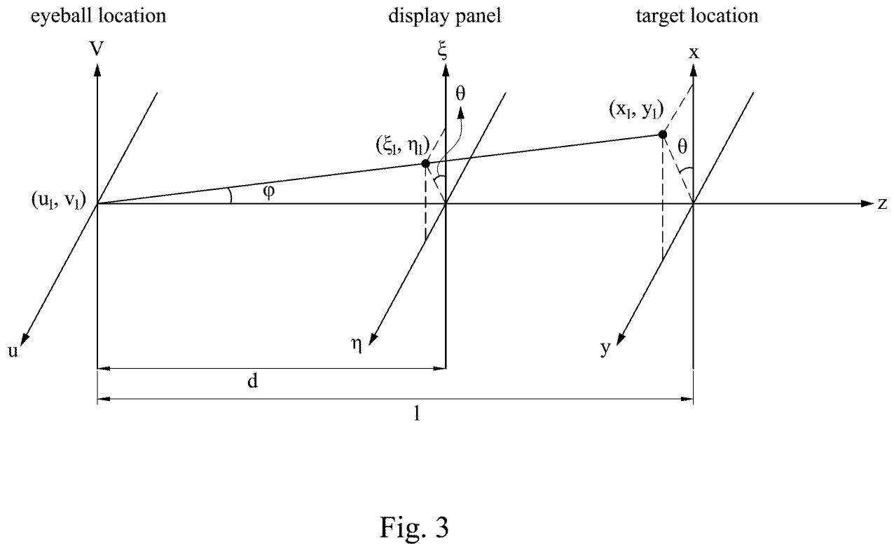

FIG. 3 illustrates a schematic view of the eyeball location E, the display panel 130 and the target location O according to one embodiment of the present disclosure. Referring to both FIG. 2 and FIG. 3, the coordinate of the eyeball location E may be expressed as (u₁, v₁), and the distance d is located between the eyeball location E and the display panel 130. The coordinate of the target location O may be expressed as (x₁, y₁), and the distance I is located between the eyeball location E and the target location O. The coordinate (ξ₁, η₁) of the blocking area 134 of the display panel 130 may be expressed as (u₁+d tan φ cos θ, v₁+d tan φ sin θ), in which θ=tan⁻¹(y₁/x₁) and φ=tan⁻¹[(y₁²+x₁²)^{0.5}/1]. For example, φ may be a zenith angle from the eyeball location E, and θ may be an azimuth angle from the eyeball location E. Specifically, the display device 100 determines the target location O. The camera 150 detects the eyeball location E and transmits the coordinates of the eyeball location E to the processor 140. The processor 140 may determine the blocking area 134 of the display panel 130 according to the mathematical formulas. The pixel units 132 located in the blocking area 134 may display as grayscale. Therefore, the pixel units 132 located in the blocking area 134 of the display panel 130 may block the object located at the target location O. The user may avoid simultaneously observing the virtual object located in front of the target location O and the object located at the target location O. The authenticity of the image L and an overall viewing experience are improved. In addition, the user may also adjust the gray level (such as the brightness and darkness) of the pixel units 132 in the blocking area 134 of the display panel 130 according to requirements to improve the viewing experience.

In addition, in some embodiments, the blocking area 134 of the display panel 130 may be determined by comparing the coordinates of the eyeball location E and the coordinates of the target location O. The blocking area 134 of the display panel 130 may determine whether each of the pixel units 132 of the display panel 130 is transparent or opaque. For example, the coordinate (x₁, y₁, z₁) of the eyeball location E and the coordinate (x₂, y₂, z₂) of the target location O are the same coordinate system. When the processor 140 determines that the coordinate (x₁, y₁) in the eyeball location E overlaps the coordinate (x₂, y₂) in the target location O, the processor 140 may determine the coordinate (z₁) in the eyeball location E and the coordinate (z₂) in the target location O. When the processor 140 determines that the coordinate (z₁) in the eyeball location E is less than the coordinate (z₂) in the target location O, the coordinate (u₁+d tan φ cos θ, v₁+d tan φ sin θ) of the pixel units 132 is set to an opaque state. When the processor 140 determines that the coordinate (z₁) in the eyeball location E is greater than the coordinate (z₂) in the target location O, the coordinate (u₁+d tan φ cos θ, v₁+d tan φ sin θ) of the pixel units 132 is set to a transparent state. The blocking area 134 of the display panel 130 may be determined. When the processor 140 determines that the coordinate (x₁, y₁) in the eyeball location E do not overlap the coordinate (x₂, y₂) in the target location O, the coordinate (u₁+d tan φ cos θ, v₁+d tan φ sin θ) of the pixel units 132 is set to an opaque state. Therefore, the pixel units 132 in the blocking area 134 of the display panel 130 may block the object located at the target location O, so that the user may avoid observing the virtual object located in front of the target location O and the object located at the target location O at the same time. As a result, a viewing experience of the image L is improved.

It is to be noted that the connection relationship of the aforementioned elements will not be repeated. In the following description, an operating method of a display device will be described.

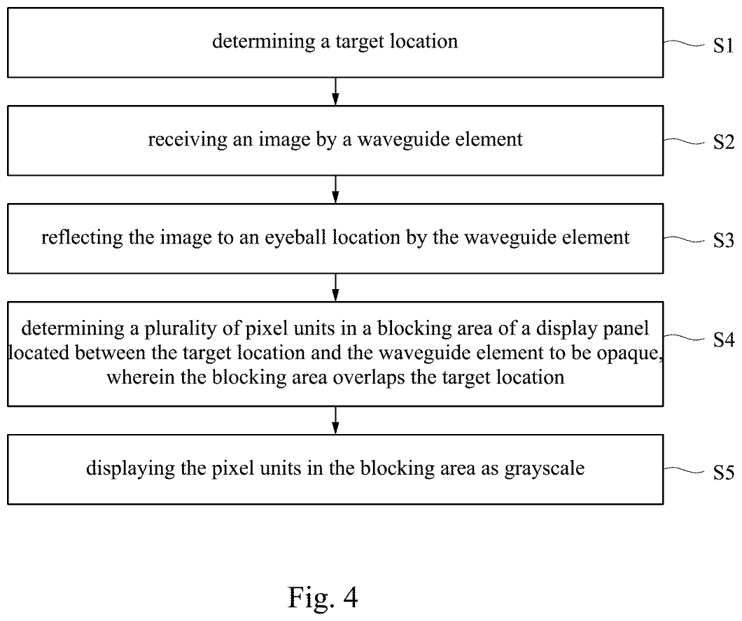

FIG. 4 illustrates a flow chart of an operating method of a display device according to one embodiment of the present disclosure. The operating method of the display device includes steps as outlined below. In step S1, a target location is determined. In step S2, an image is received by a waveguide element. In step S3, the image is reflected to an eyeball location by the waveguide element. In step S4, a plurality of pixel units in a blocking area of a display panel located between the target location and the waveguide element are determined to be opaque, wherein the blocking area overlaps the target location. In step S5, the pixel units in the blocking area display as grayscale. In the following description, the aforementioned steps will be described in detail.

Referring to FIG. 2, the display device 100 may determine the target location O. After the display device 100 determines the target location O, the image generating unit 110 may transmit the image L to the waveguide element 120. That is, the waveguide element 120 may receive the image L. Next, the waveguide element 120 may make the image L to be totally reflected in the waveguide element 120, and the waveguide element 120 may reflect the image L to the eyeball location E. The user's eyes may be located at the eyeball location E to receive the image L transmitted by the image generating unit 110. In addition, the image L may be combined with the information of the real scene and transmitted to the eyeball location E. The processor 140 may determine the blocking area 134 of the display panel 130 according to the target location O. In detail, the blocking area 134 of the display panel 130 overlaps the target location O. The processor 140 may determine the pixel units 132 located in the blocking area 134 to be an opaque state. In some embodiments, after the processor 140 determines the blocking area 134 of the display panel 130, the pixel units 132 located in the blocking area 134 may display as grayscale to block the object located at the target location O, so that the user does not observe the object located at the target location O.

In some embodiments, the processor 140 may further determine the pixel units 132 of the display panel 130 outside the blocking area 134 to be a transparent state. In addition, the processor 140 determines the pixel units 132 in the blocking area 134 of the display panel 130 to be opaque according to the eyeball location E and the target location O. In addition, the processor 140 determines the pixel units 132 in the blocking area 134 of the display panel 130 to be opaque so that the blocking area 134 of the display panel 130 partially overlaps the eyeball location E. The user may observe the virtual object located in front of the target location O to improve the authenticity of the image L. The user may receive the information of the real scene, thereby improving an overall viewing experience. In addition, the operating method further includes detecting the eyeball location E through the camera 150 electrically connected to the processor 140. After detecting the eyeball location E, the camera 150 may transmit the coordinates of the eyeball location E to the processor 140. The processor 140 may determine the blocking area 134 of the display panel 130, and the pixel units 132 located in the blocking area 134 may display as grayscale. Therefore, the pixel units 132 in the blocking area 134 of the display panel 130 may block the object at the target location O, so that the user may avoid observing the virtual object in front of the target location O and the object at the target location O at the same time. In addition, the user may adjust the gray level (such as the brightness and darkness) of the pixel units 132 in the blocking area 134 of the display panel 130 according to requirements, so an overall viewing experience is improved.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A display device configured to determine a target location, the display device comprising:
a waveguide element configured to receive an image and reflect the image to an eyeball location;
a display panel located at one side of the waveguide element and having a plurality of pixel units, wherein the display panel is located between the waveguide element and the target location; and
a processor electrically connected to the display panel and configured to determine the pixel units in a blocking area of the display panel to be opaque, wherein the blocking area of the display panel overlaps the target location, and the display panel displays the pixel units in the blocking area as grayscale according to the processor.

2. The display device of claim 1, further comprising:
a camera electrically connected to the processor.

3. The display device of claim 2, wherein the camera is configured to detect the eyeball location.

4. The display device of claim 2, wherein the camera is located between the eyeball location and the display panel.

5. The display device of claim 1, wherein the waveguide element is located between the eyeball location and the display panel.

6. The display device of claim 1, wherein the waveguide element is closer to the eyeball location than the display panel.

7. The display device of claim 1, wherein the display panel is closer to the target location than the waveguide element.

8. The display device of claim 1, wherein the blocking area of the display panel partially overlaps the eyeball location.

9. The display device of claim 1, wherein the processor is configured to determine the blocking area of the display panel according to the target location.

10. The display device of claim 1, wherein the processor is configured to determine the blocking area of the display panel according to the eyeball location.

11. The display device of claim 1, wherein the waveguide element and the display panel are separated from each other.

12. An operating method of a display device, comprising:
determining a target location;
receiving an image by a waveguide element;
reflecting the image to an eyeball location by the waveguide element;
determining a plurality of pixel units in a blocking area of a display panel located between the target location and the waveguide element to be opaque, wherein the blocking area overlaps the target location; and
displaying the pixel units in the blocking area as grayscale.

13. The method of claim 12, wherein determining the pixel units in the blocking area to be opaque is performed according to the eyeball location.

14. The method of claim 12, wherein determining the pixel units in the blocking area to be opaque is performed according to the target location.

15. The method of claim 12, wherein determining the pixel units in the blocking area to be opaque is performed such that the blocking area of the display panel partially overlaps the eyeball location.

16. The method of claim 12, further comprising:
detecting the eyeball location by a camera.

17. The method of claim 12, wherein determining the pixel units in the blocking area of the display panel to be opaque further comprises:
determining the pixel units of the display panel outside the blocking area to be transparent.
